(19) United States
(12) Patent Application Publication
(10) Pub. No.: US 2017/0297220 A1
(43) Pub. Date: Oct. 19, 2017

(54) Cooling Device for Flat Pieces and Method for Cooling Flat Pieces

(71) Applicant: BIELE, S.A., Azpeitia (ES)

(72) Inventor: Francisco Javier Aldazabal Badiola, Azpeitia (ES)

(21) Appl. No.: 15/471,519

(22) Filed: Mar. 28, 2017

(30) Foreign Application Priority Data
Mar. 30, 2016 (ES) P201630368

(51) Int. Cl. B27N 3/18; F28F 5/00; F28D 15/00

(52) U.S. Cl. CPC B27N 3/18; F28D 15/00; F28F 5/00

(57) ABSTRACT

A cooling device for flat pieces and a method including a first cooling element with a first contact surface with the flat piece and a second cooling element with a second contact surface with the flat piece; wherein the first and second cooling element are located facing each other, defining a space between them to introduce the flat piece, and wherein the first cooling element includes a cooling circuit and second cooling element includes another cooling circuit, respectively, distributed evenly along the first and second contact surface with the flat piece through which a continuous flow of liquid coolant circulates. The flat piece is cooled until it reaches the desired temperature in order to then be removed and stored.

### CROSS-REFERENCE TO RELATED APPLICATION

This application claims priority to Spanish Patent Application No. P201630368 filed Mar. 30, 2016, the disclosure of which is hereby incorporated in its entirety by reference.

### OBJECT OF THE INVENTION

The present invention relates to a novel cooling device for flat pieces and a method for cooling the flat pieces that uses the device mentioned. The device has cooling elements, preferably plates, which are in contact with the flat pieces through whose interior a coolant fluid continuously and constantly flows to exchange heat with the pieces. In this way, it is able to quickly and homogeneously cool the flat pieces, reducing as much as possible the energy costs associated with the process.

The invention falls under the technical field of manufacturing substantially flat products, preferably made from compressed wood, through hot processes.

### BACKGROUND OF THE INVENTION

Cooling boards after a hot-pressing process is carried out in different ways in the state of the art. The objective of these processes is to reduce the temperature of the pressed boards before their storage and/or distribution. By failing to do so and stacking the boards while hot, said boards undergo a heterogeneous cooling process wherein different parts of the same board cool at different rates, and depending on their position in the stack, the boards also cool at rates different from each other. Therefore, neither the individual boards nor the stack of boards as a whole cool evenly and said boards end up bending. This necessarily implies either discarding the boards that have bent, thus increasing production costs, or subjecting them to straightening processes that prolong the manufacturing process and also increase production costs.

Currently, after the hot-pressing process, the laminated boards are air-cooled in different cooling devices that store the boards, maintaining a specific distance between them until they reach the desired temperature. These cooling devices have elements (surfaces, arms or similar) upon which the boards are supported, maintaining a distance between them that allows heat to dissipate.

Among these cooling devices, radial storage coolers for plywood boards, for example, are known. They have a plurality of securing arms (generally two parallel metal bars for each board) arranged radially to form a cylinder of revolution, such that the rotation of this cylinder aerates and cools the boards. The boards are kept in this rotary cooler for a minimum of 30 minutes before being packaged and stored.

Vertical storage coolers for plywood boards are also known. They have a plurality of securing arms (generally two parallel metal bars for each board), all arranged in parallel like a shelf space, such that the space between each pair of arms upon which a single board is supported allows the boards to be sufficiently aerated. The boards remain in this static vertical storage cooler for a minimum of 30 minutes before being packaged and stored.

The problem of both radial and vertical storage coolers for plywood boards is that the cooling process requires an amount of time that depends on the temperature of the manufacturing process of the boards and the room temperature. This time during which the panels should be stored increases the production times, and as a result, increases costs. Furthermore, a greater distance between the boards will accelerate the cooling process but implies the need for more storage space for the same amount of boards, such that there should be large storage spaces or prolonged cooling times, which leads to a prolonged manufacturing process.

Coolers for melamine boards are also known, which cool the boards by introducing them into partially or completely closed spaces wherein cold air is injected. This way, the cooling process is accelerated at the expense of greater energy consumption which significantly increases production costs.

Therefore, it is necessary to design a device and a method that makes it possible to reduce the cooling times of the flat panels manufactured by any process that involves their heating, without it involving a significant increase in energy consumption. This will make it possible to optimize the production time while keeping costs within profit margins.

### DESCRIPTION OF THE INVENTION

With the aim of solving the aforementioned problems, the present invention describes a cooling device for flat pieces and a method for cooling flat pieces that uses the mentioned cooling device. The invention improves the existing cooling processes of flat pieces coming from pre-manufacturing processes by means of heat presses. Currently, there are many pressing processes on the market wherein, in addition to pressure, the influence of heat is essential, for example, in the manufacture of laminated boards, metal and polymer plates, or fiber cement sheets.

Therefore, a first object of the invention is a cooling device for flat pieces comprising a first cooling element having a first contact surface with the flat piece and a second cooling element having a second contact surface with the flat piece. The first and second cooling elements are located facing each other, defining a space between them to introduce the flat piece. Additionally, both the first cooling element and the second cooling elements comprise each one a cooling circuit distributed evenly along the first and second contact surface with the flat piece, respectively, through which a continuous flow of the coolant fluid circulates. The heat exchange between the coolant fluid and the flat piece will cool the piece by heating the coolant fluid, since its circulation and constant renewal will dissipate the heat transmitted by the piece. Note that throughout the specification, the mention of flat pieces refers to substantially flat pieces, in other words, pieces defined on a single plane. Thus, the surfaces of the flat pieces in contact with the cooling elements do not necessarily have to be smooth, but instead can have irregular surfaces, reliefs, grooves, etc. Preferably it is provided that at least one of the contact surfaces of the pieces with the cooling device is smooth in order to maximize the contact surface with the corresponding cooling element. Furthermore, it is provided that said flat pieces are preferably made of laminated wood, melamine, plastic, polymers or metal. Therefore, in a preferred embodiment of the invention, said pieces will have a constant thickness although optionally they can have a variable thickness, especially when they are polymer pieces.

In a preferred embodiment, the device comprises a movement system of at least one of the cooling elements in order to move said cooling element with respect to the other cooling element in a direction perpendicular to the contact surfaces. Optionally, it is provided that the two cooling elements can have a movement system, especially when none of them are used as a support surface for the flat piece, for example, in applications wherein the cooling elements are arranged vertically. With these movement systems, it is ensured that the contact surfaces of the cooling elements are always in contact with the piece and it also allows the invention to be more versatile, adapting to pieces with varying thicknesses.

In another particular embodiment, the cooling device comprises a first cooling system to power the cooling circuit of the first cooling element and a second cooling system to power the cooling circuit of the second cooling element, both cooling systems being independent from each other. These cooling systems will be connected to the same cooler or to two independent and external coolers, which will receive a flow of the reheated liquid coolant during the time that it circulates through the cooling circuits and will return it to the working temperature.

In another particular embodiment, the device comprises a single cooling system to power the cooling circuits of the first and second cooling element. This will be especially useful in applications where space is limited. In this case, the cooling system will be connected to a single cooler.

In another particular embodiment, the movement system of the cooling elements comprises a plurality of hydraulic cylinders. These cylinders will be connected to a frame that supports the device and to those cooling elements. Optionally, the movement system can be comprised of pneumatic cylinders or motorized cylinders.

In another particular embodiment, the system additionally comprises an automatic loading and unloading system of flat pieces that is coupled to the device itself. More preferably, it is provided that the loading and unloading system of the flat pieces is a band made of Mylar® material coupled to the contact surface of at least one of the cooling elements. It is also provided that the loading and unloading system can have motorized wheels.

In another particular embodiment, the first and second cooling element comprises a plurality of coolant fluid inlets and outlets on surfaces opposite to the contact surfaces of the flat pieces. The coolant fluid at working temperature will be introduced by means of the cooling systems and through the inlets, and the reheated coolant fluid will exit through the outlets once it has traveled through the cooling circuit. It is provided that in another particular embodiment of the invention, each cooling element has a first coolant fluid distributor connected to the plurality of coolant fluid inlets and a second coolant fluid distributor connected to the plurality of coolant fluid outlets. These distributors are elements that are located between the external cooler, which forms part of the cooling system and which cools the coolant fluid to the working temperature, and the cooling device.

In another particular embodiment, the cooling circuit of the first cooling element and the cooling circuit of the second cooling element is made up of a plurality of coils distributed along the contact surface of the flat piece, through which the coolant fluid circulates. The distribution can vary and it will be configured to maximize heat exchange between the cooling elements and the flat piece. For the case in which the flat pieces have variable thicknesses or irregular contact surfaces, the distribution of the coils will be adjusted for that purpose, having a higher density of the same in thicker areas.

In another particular embodiment, the first and second cooling elements are preferably flat and with dimensions that are identical and substantially equal to the dimensions of the flat piece. It is also provided that the dimensions cannot be adjusted to pieces in cases where only a part of them is to be cooled or where the cooling elements can have dimensions that are different from each other. The dimensions as well as the shape of the contact surfaces of the cooling elements with the flat pieces will depend on the specific application and the nature and shape of the flat pieces.

In another particular embodiment, the coolant fluid is water at room temperature. Nevertheless, other coolants, such as air, freon, etc., at very different temperatures can be used.

In another particular embodiment, the cooling device comprises a plurality of first cooling elements and second cooling elements, wherein each pair of first and second cooling elements are arranged horizontally on the same horizontal plane and are aligned. Thus, for this specific arrangement, a single loading and unloading system is used for all cooling elements. It is also provided that the pairs of the first and second cooling elements can be arranged in parallel and aligned, either vertically or horizontally, although for this embodiment, both loading and unloading systems and pairs of first and second cooling elements are needed.

In the case of horizontal arrangement, on the same horizontal plane and aligned, a plurality of cooling devices are provided, such as the ones previously described which are placed in a row (a single loading and unloading system for all cooling devices). In the case of parallel arrangement, a plurality of cooling devices are placed parallel to each other (for both loading and unloading systems and cooling devices).

Preferably, it is provided that all cooling elements are arranged horizontally and aligned vertically to optimize space. In this case, an upper cooling element, a lower cooling element and a plurality of intermediate cooling elements are defined. These intermediate cooling elements act as a first cooling element with respect to the cooling element located directly below it, and as a second cooling element with respect to the cooling element located directly above it. Each pair of cooling elements defines a space between them to introduce a flat piece. In this way, the cooling device is configured to simultaneously cool a plurality of flat pieces, as many as there are pairs of first-second cooling elements that couple to the frame of the device. The intermediate cooling elements can have a cooling circuit on each of their two contact surfaces with flat pieces, or a single cooling circuit to cool both contact surfaces. In this multi-load cooling device, it is provided that the means for moving the cooling elements preferably comprise a motorized lifting system to optimize the space occupied.

Similar to that described in the previous paragraph, it is provided that all cooling elements are preferably arranged vertically and aligned horizontally to optimize space. In this case, a left-side cooling element, a right-side cooling element and a plurality of intermediate cooling elements are defined. Thus, the right-side cooling element acts as a first cooling element with respect to the cooling element located directly to the left that acts as a second cooling element, and so on until arriving at the left-side cooling element that will act as a second cooling element of the cooling element located directly to the right. Each pair of cooling elements defines a space between them to introduce a flat piece. In this way, the cooling device is configured to simultaneously cool a plurality of flat pieces, as many as there are pairs of first-second cooling elements that couple to the frame of the device.

For the embodiment with a horizontal arrangement as well as that with a vertical arrangement, the cooling systems and the coolers can be common to all cooling devices or groups of them, or they can be connected individually, such that there will be as many as there are cooling devices.

A second object of the invention is a method for cooling the flat pieces that uses the previously described cooling device, characterized in that it comprises the following phases:

Circulating the coolant fluid through the cooling circuit of the first cooling element and through the cooling circuit of the second cooling element;

Introducing the flat piece into the space defined between the first cooling element and the second cooling element;

Keeping the flat piece in contact with the first contact surface of the first cooling element and in contact with the second contact surface of the second cooling element for a pre-established time, the pre-established time depending on the initial temperature and final temperature of the flat piece, and the temperature of the coolant fluid; and,

Separating the first cooling element from the second cooling element by means of a movement system and removing the flat piece from the space defined between the first and second cooling element.

In a particular embodiment, after introducing the flat piece into the space defined between the first and second cooling element, the distance between the first and second cooling element is adjusted by means of the movement system of the cooling elements so that the first and second contact surface come in contact with the flat piece.

In another particular embodiment, the pre-established time during which the flat piece is kept in contact with the first and second contact surface of the first and second cooling element is at least one minute per millimeter of thickness of the flat pieces, when the coolant fluid is water at room temperature. In cases where the fluid has a lower temperature or the coolant fluid has better heat-carrying properties, the pre-established temperature can be reduced.

In another particular embodiment, it is provided that the flat pieces have a minimum thickness of 0.4 mm. Preferably, it is provided that the maximum thickness of the pieces is 60 mm, although this parameter will depend on the final application of the product obtained.

The advantages of the device and method herein described with regards to the state of the art include:

It quickly and evenly cools the flat pieces, for example, boards. Currently, the cooling of hot boards once they are stored and stacked is very slow and very uneven. The upper boards and the edges of the stack cool very quickly, but the inside of the stack may need several days to cool. This leads to bends and deformities of the boards, requiring manufacturers to have large warehouses and extend delivery times.

It prevents bending of the flat pieces during the cooling phase by placing said boards between two cooling elements, for example, plates, with contact and support surfaces that adapt to the shape of the boards. In general, the flat pieces that leave the hot press are often not hardened and they cannot support their own weight, such that when they are placed between slats (vertically) or on shelves (horizontally), they usually bend.

The cooling elements in contact with the flat pieces in the present invention are kept at a constant temperature, such that the heat exchange between them and the flat pieces is even. Other existing solutions do not ensure even cooling, since the areas supported on the slats or shelves will cool in different ways.

The coolant fluid used will preferably be water at room temperature, although other coolants that reduce the temperature of the cooling elements to below room temperature can also be used, thus accelerating the cooling process. Therefore, the rate of the cooling process can be modified depending on the needs.

### BRIEF DESCRIPTION OF THE FIGURES

As a complement to the description provided herein, and for the purpose of helping to make the characteristics of the invention more readily understandable, a set of drawings is attached as an integral part of said description, which, by way of illustration and not limitation represent the following:

FIG. 1 is a perspective view of the first exemplary embodiment of the cooling device for flat pieces, wherein the pair of cooling elements are arranged horizontally.

FIG. 2 is a front view of the cooling device of FIG. 1.

FIG. 3 is a side view of the cooling device of FIG. 1.

FIG. 4 is an upper plan view of the cooling device of FIG. 1.

FIG. 5 is a detail view of the cooling circuit of one of the cooling plates of the device shown in FIGS. 1-4, 7 and 8.

FIG. 6 is a perspective view of an exemplary embodiment of a vertical cooling device made up of a plurality of cooling elements arranged horizontally and aligned vertically, which is configured to simultaneously cool up to nine flat boards.

FIG. 7 is a perspective view of another exemplary embodiment of the cooling device for flat pieces, equivalent to that of the preceding figure, but in this case, the cooling elements are arranged vertically, aligned horizontally and configured to simultaneously cool up to four flat boards.

FIG. 8 is a front view of the cooling device of FIG. 7.

### DESCRIPTION OF SEVERAL EXEMPLARY EMBODIMENTS OF THE INVENTION

A description of several exemplary embodiments of the invention follows, by way of illustration and not limitation, referring to the numbers provided in the figures.

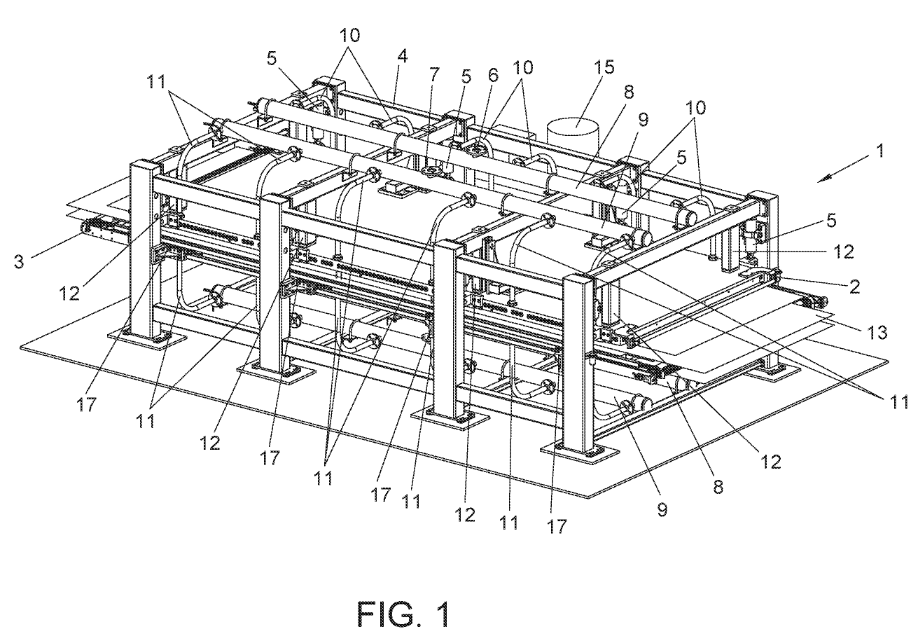

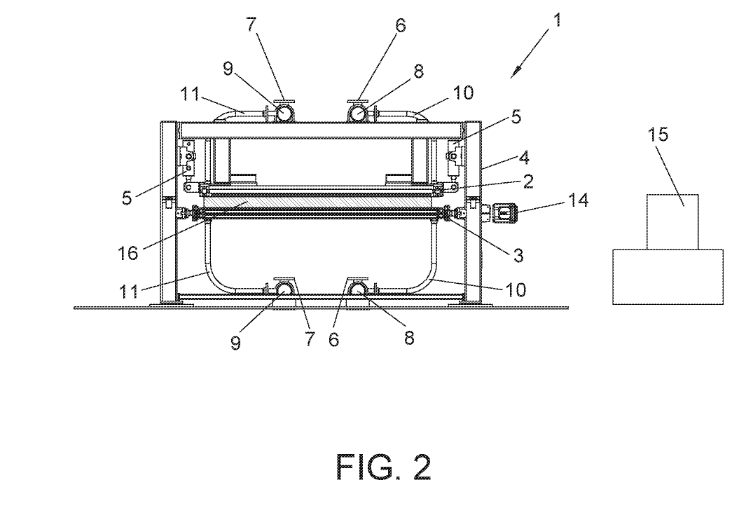

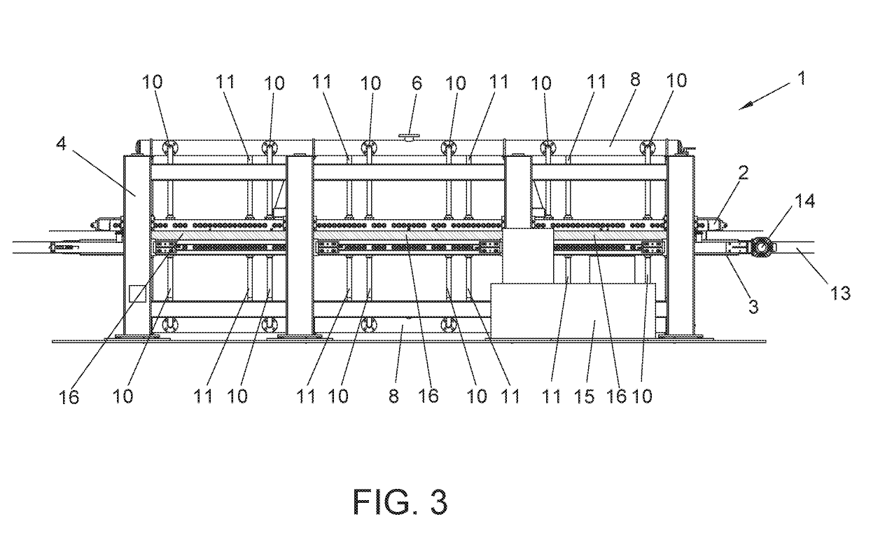

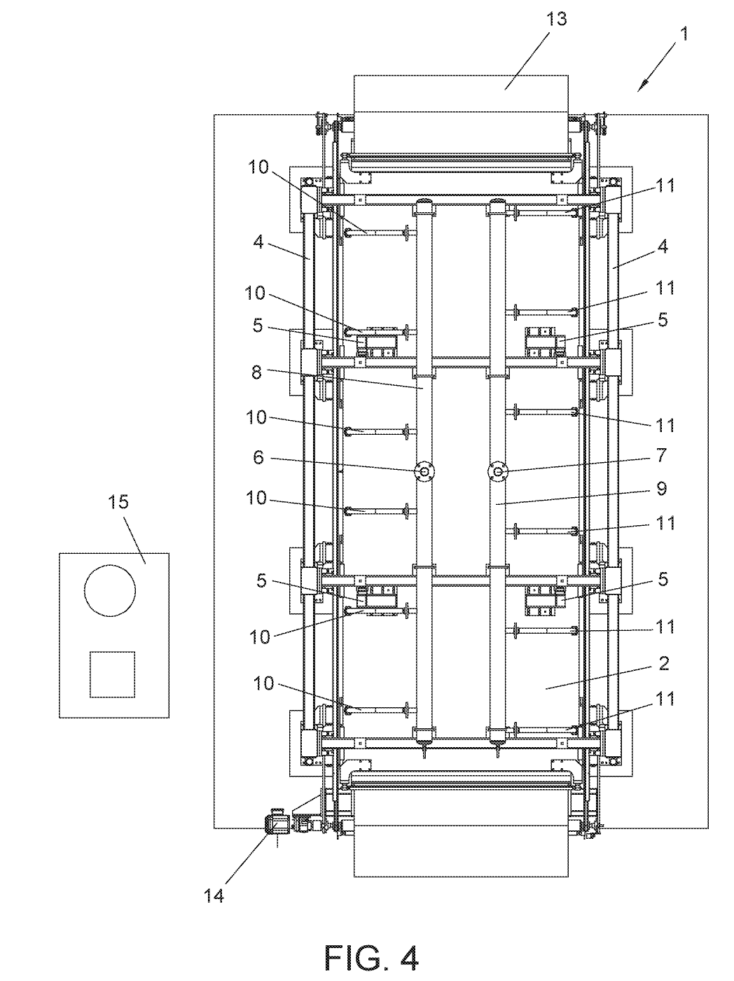

FIGS. 1-4 show different views of the same exemplary embodiment of the cooling device for flat pieces (16). This particular embodiment is provided for the cooling of a single flat piece (16), for example, a laminated board previously manufactured by means of a hot press, since it only has two cooling elements, such as cooling plates (2, 3) that are arranged parallel to the floor. Specifically, FIG. 1 shows a perspective view of a particular embodiment of the cooling device (1), wherein the board has not been included, and FIG. 2 shows a front view of the same embodiment, wherein the board (16) is shown, cooling; meanwhile, FIGS. 3 and 4 show a side view and an upper plan view, respectively, of this same embodiment.

The cooling device (1) is mounted on a metal frame (4) that is fixed to the floor. The upper (2) and lower (3) plates of the cooling device (1) are cooled, in this particular case, with water at room temperature. This exemplary embodiment was designed to keep the boards between the two plates (2, 3) during a cooling time of one minute per each mm of board thickness. Nevertheless, other coolants can be used or their temperature can be lowered to lower the cooling times.

The cooling device (1) has means for moving which comprise eight hydraulic cylinders (5) located on the edges of the upper plate (2) and distributed at equal distances and corresponding to the feet of the frame (4). These hydraulic cylinders (5) are configured to move the upper plate (2) vertically with respect to the lower plate (3), which, in this case, is fixed to the frame (4) by means of brackets (17). In this way, during the process of introducing and removing the board, the hydraulic cylinders (5) increase the separation between both plates (2, 3) by lifting the upper plate (2), and during the cooling stage and with the board inside the existing gap between both plates (2, 3), the cylinders (5) lower the upper plate (2) until it comes in contact with the board. Furthermore, these means for moving can be coupled to the lower plate, keeping the upper plate fixed, or they could move both plates together. Given that the aim of these means for moving is not to press, but rather to simply ensure contact between the piece and the cooling plates, the means for moving are very simple, such that the perfectly horizontal movement of the entire plate is not considered to be critical. Furthermore, the frame (4) has stops (12) to limit the movement of the upper plate (2) carried out by the hydraulic cylinders (5).

FIGS. 2 and 3 shows the board (16) located in the gap between both plates (2,3), such that the inner surface of the board (16) is supported on the contact surface of the lower plate (3) and the cylinders (5) have been activated to move the upper plate (2) until its contact surface comes in contact with the upper surface of the board (16). In this exemplary embodiment, the design of both plates (2, 3) is identical and it adjusts to the dimensions of the board, since it aims to provide equal and even cooling to both faces of the board, although, depending on the nature of the piece to be cooled, plates with different shapes and sizes could be used such that they cool different surfaces of the piece at different rates or do so partially.

The plates (2, 3) have inlets (6) and outlets (7) for water on the face opposite to the contact face of the board (16). Connected to each inlet (6) and outlet (7) is a cold-water inlet distributor (8) and another for the hot-water outlet (9). The cold-water inlet distributor (8) connects six cold-water inlet points to the plate via first connecting tubes (10). Likewise, the hot-water outlet distributor (9) connects six hot-water outlet points to the plate via second connecting tubes (11). FIGS. 1-4 do not show the connecting ducts between the cooler (15) and the inlets (6) and outlets (7) of the device (1).

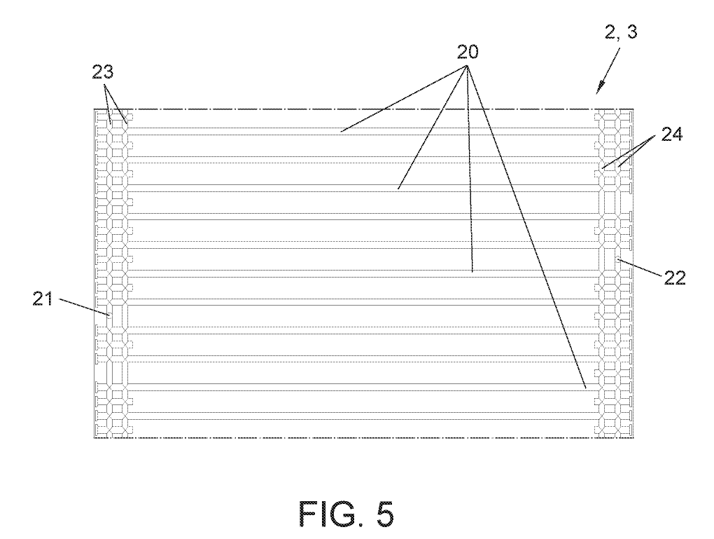

Regarding the design of the cooling circuits of each of the plates (2, 3) in this particular embodiment, the circuits are made up of coils (20) that distribute the cold water introduced through the cold-water inlets (21) and distributed through perpendicular channels (23) that distribute cold water, which are connected to the coils (20). The coils (20) homogeneously distribute the water along the entire surface of the plate from one of the sides, the reheated water being collected by hot-water reception channels (24) located on the opposite side, and ultimately being removed by the hot-water outlets (22), as shown in FIG. 5. In this way, the temperature of the plate is as homogeneous as possible so that cooling is also homogeneous. The plate is designed so that the same water flow passes through each cooling circuit and cools homogeneously. The separation and diameter of the holes of the channels (23, 24) and coils (20) are calculated to provide the largest exchange surface possible and to facilitate cooling. Other distributions are perfectly viable, provided that the distribution of the coolant fluid is homogeneous along the contact surface of the plates.

The cooling device (1) also has a board loading and unloading system. In this embodiment, the selected system is a loading system by means of a lower band made of Mylar® (13) driven by a motor (14) coupled to the lower plate (3). Nevertheless, other loading and unloading systems can be used, such as conveyor carriages with suction cups, etc. The use of loading systems with a lower band made of Mylar® has the advantage of having a reduced cost. Another advantage of the loading and unloading system with the Mylar® band is that the unloading of the board, as well as the loading of the following board, can be carried out simultaneously.

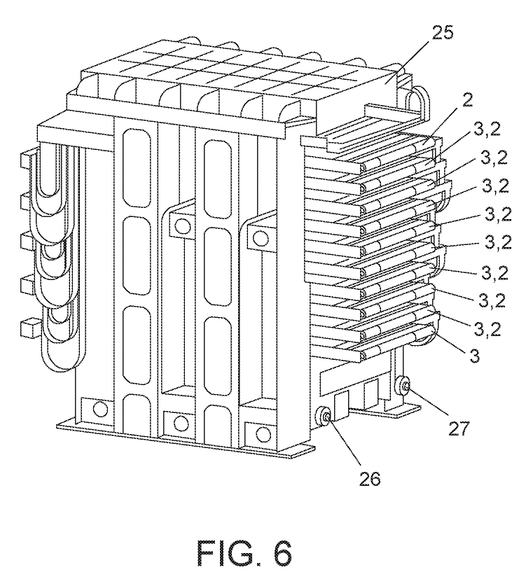

FIG. 6 shows an exemplary embodiment of the cooling device made up of a plurality of cooling plates that is configured to simultaneously cool up to nine flat boards.

Thus, there are nine pairs of plates (2, 3) placed in parallel planes, aligned vertically and coupled to the same frame (25). Thus, ten plates, one upper (2), one lower (3) and eight intermediate, are used, which act as a first cooling element (2), with respect to the cooling element located directly below it, and as a second cooling element with respect to the cooling element located directly above it. In this case, to optimize the space, instead of hydraulic cylinders, there is a motorized lifting system to move the plates (2, 3) vertically. Furthermore, it has a single cold-water inlet distributor (26) and another for the hot-water outlet (27). The cold-water inlet distributor (26) connects to several points on the cold-water inlet of all plates (2, 3) via first connecting tubes (not shown). Likewise, the hot-water outlet distributor (27) connects to several points on the hot-water outlet of all plates (2, 3) via second connecting tubes (not shown). In this case, the intermediate plates will cool the boards in contact with both their lower and upper surface.

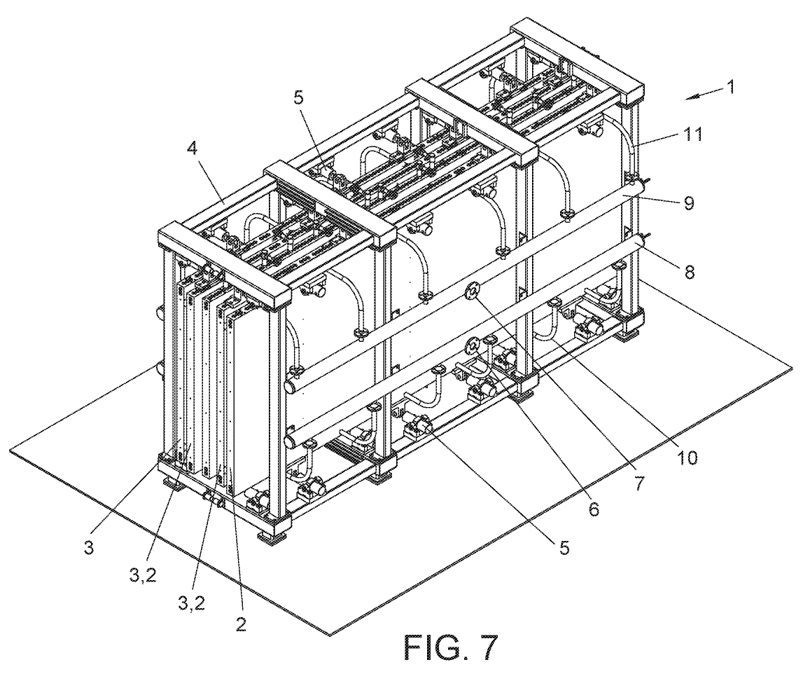

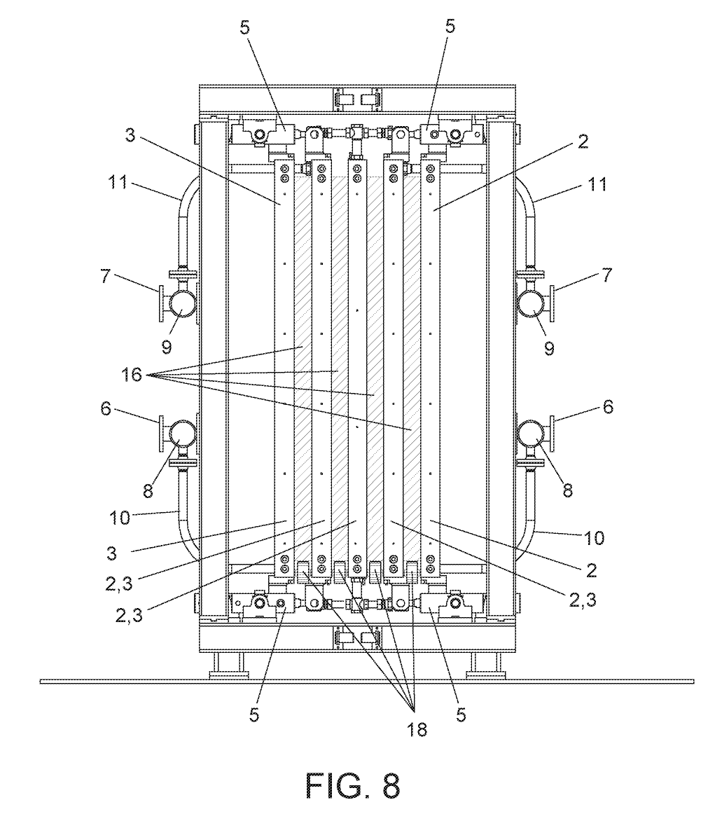

FIGS. 7 and 8 show an exemplary embodiment wherein four boards (16) are simultaneously cooled by means of pairs of plates (2, 3) arranged vertically instead of horizontally, as shown in the embodiment in FIGS. 1-4 and 6. The boards (16) are only shown in FIG. 8 and not in 7. In this case, the operation is equivalent to that described, such that it comprises the corresponding cylinders (5), but in this case, they are configured to horizontally move at least one of the plates (2, 3).

FIG. 8 shows the boards (16) located in the gap between the plates (2, 3) in the position in which they are being cooled.

In this case, the plates (2, 3) also comprise inlets (6) and outlets (7) of water or any other coolant, as well as a cold-water inlet distributor (8) and another for the hot-water outlet (9), and likewise, the cold-water inlet distributor (8) connects six cold-water inlet points to the plate via first connecting tubes (10). Likewise, the hot-water outlet distributor (9) connects six hot-water outlet points to the plate via second connecting tubes (11).

Likewise, the cooling circuits of each of the plates (2, 3) further comprise coils (20) for the distribution of cold water that is introduced into the cold-water inlets (21) and is distributed by perpendicular channels (23) for the distribution of cold water, which are connected to the coils (20). The coils (20) homogeneously distribute the water along the entire surface of the plate from one of the sides, the reheated water being collected by the hot-water reception channels (24) located on the opposite side and ultimately being removed by the hot-water outlets (22), as shown in FIG. 5.

In this embodiment, it is also provided that a board loading and unloading system can be incorporated, but in this case, by means of motorized wheels (18) to carry out vertical loading, instead of using motors (14) as carried out in the preceding embodiment in FIGS. 1-4 and 6.

Regarding the cooling process of the boards, firstly and before introducing the boards, the water flow at room temperature is circulated through the plates until they reach the temperature of the water (or any other coolant fluid). Once the plates are at room temperature, the boards can then be introduced between each pair of plates and the cooling process can begin. The cooling system, which constantly re-circulates the water, is designed to instantly dissipate the heat coming from the board, such that the temperature of the water and the board always remain constant. In this way, the reheated water coming from the cooling device is led to the external cooler (15) that lowers its temperature to room temperature and stores it in a tank. The system reinjects by means of a pump the already cooled water from the tank to the device. Even when the cooling device is open (separated plates) and awaiting the insertion of a piece, the pump of the cooling system will continue to introduce cooled water so that the temperature of the plate remains constant at the value desired and it is not affected by variations in room temperature.

The permanence time of a board between the cooling plates is calculated with heat conduction equations.

$$k ( \frac{{\partial }^{2} T}{\partial {x}^{2}} + \frac{{\partial }^{2} T}{\partial {y}^{2}} + \frac{{\partial }^{2} T}{\partial {z}^{2}} ) + {{q}^{′}}_{G}^{″} = ρ c \frac{\partial T}{\partial t}$$

### Where:

k: Thermal conductivity
c: Specific heat capacity
p: Mass density of the material
q_{G}′″: Energy generated per volume unit
T: Temperature
t: Time
x, y, z: Dimensions

These equations are not linear, in other words, there is no thickness-permanence time factor. Nevertheless, in the case of boards manufactured via hot-pressing processes, it has been found that with a permanence time equal to the pressing time, in other words, one minute per millimeter of thickness, the boards are sufficiently cooled.

In a specific embodiment, the aim is to cool a 20-mm-thick laminated board, manufactured by means of a heating process, such that afterwards, the board is at 200° C. and therefore will stay in the cooling device for 20 minutes. The process is provided to progressively cool a wooden board that is in direct contact with steel sheets (contact surfaces of the plates), the core of which has a constant temperature (35° C. to prevent condensation due to the surrounding air humidity). After 20 minutes, the board will leave the cooling device at a temperature that will oscillate between 35° C. and 50° C.

At the beginning of the process, the greater the temperature difference between the board and the plate, the greater the power dissipated and the greater the power that must be supplied to the plate. In this specific embodiment, the board has a surface area of 10 m², such that it needs a maximum of 12000 W/m² and it would be necessary to have external coolers with a capacity of: 12000×10×2 (upper face and lower face of the board)=240 kW. Nevertheless, all this power will only be used during a very short period of time (specifically, the first minutes of the cooling process, since as the temperature of the board decreases, the amount of power needed decreases), while it will not be necessary for the rest of the time.

To avoid having to significantly oversize the external cooler, an accumulation facility is designed, such that:

The average power of the process is 3300 W/m². In other words: 3300×10×2=66 kW. An external cooler with said power is installed. The first seven minutes of the process require more than 3300 W/m² and the following twelve minutes need less power since the temperature of the board will gradually decrease. A 10,000-liter collection tank that is capable of storing water at 35° C., which is necessary during the first seven minutes, is installed. During the following twelve minutes, since less power is needed than what is available, the external cooler is in charge of restoring the temperature of the tank to 35° C. for the following cycle.

1. A cooling device for flat pieces, comprising:
a first cooling element having a first contact surface with a flat piece;
a second cooling element having a second contact surface with the flat piece;
wherein the first cooling element and second cooling element are located facing each other, defining a space between them to introduce the flat piece, and wherein the first cooling element comprises a cooling circuit distributed along the first contact surface with the flat piece and the second cooling element comprises a cooling circuit distributed along the second contact surface with the flat piece, both circuits being configured for the continuous flow of a coolant fluid.

2. The cooling device of claim 1, further comprising a movement system for moving at least one of the cooling elements with respect to the other in a direction perpendicular to the contact surfaces.

3. The cooling device of claim 1, further comprising a first cooling system to power the cooling circuit of the first cooling element and a second cooling system to power the cooling circuit of the second cooling element.

4. The cooling device of claim 2, further comprising a first cooling system to power the cooling circuit of the first cooling element and a second cooling system to power the cooling circuit of the second cooling element.

5. The cooling device of claim 1, further comprising a single cooling system to power the cooling circuits of the first and second cooling element.

6. The cooling device of claim 2, further comprising a single cooling system to power the cooling circuits of the first and second cooling element.

7. The cooling device of claim 2, wherein the movement system of the cooling elements comprises a plurality of cylinders selected among hydraulic, pneumatic and motorized.

8. The cooling device of claim 1, further comprising an automatic loading and unloading system of the flat pieces coupled to the device.

9. The cooling device of claim 8, wherein the loading and unloading system of the flat pieces is a band of polyethylene terephthalate material coupled to the contact surface of at least one of the cooling elements and motorized wheels.

10. The cooling device of claim 1, wherein the first cooling element and second cooling element each comprise at least one coolant fluid inlet and outlet disposed on surfaces opposite to the contact surfaces of the flat pieces.

11. The cooling device of claim 10, wherein each cooling element comprises a first liquid coolant distributor connected to the coolant fluid inlet and a second coolant fluid distributor connected to the coolant fluid outlet.

12. The cooling device of claim 1, wherein the cooling circuit of the first cooling element and the cooling circuit of the second cooling element comprise a plurality of coils distributed along the contact surface of the flat piece, through which the coolant fluid circulates.

13. The cooling device of claim 1, wherein the first and the second cooling elements are flat and with dimensions that are substantially equal to the dimensions of the flat piece.

14. The cooling device of claim 1, wherein the coolant fluid is water at room temperature.

15. The cooling device of claim 1, further comprising a plurality of first cooling elements and second cooling elements, and wherein each pair of first and second cooling elements are arranged and aligned on the same horizontal plane.

16. The cooling device of claim 1, further comprising a plurality of first cooling elements and second cooling elements arranged horizontally and aligned vertically, wherein all cooling elements face each other, defining a space between each pair of cooling elements to introduce a flat piece, such that the cooling device is configured to simultaneously cool a plurality of flat pieces.

17. The cooling device of claim 1, further comprising a plurality of first cooling elements and second cooling elements arranged vertically and aligned horizontally, wherein all cooling elements face each other, defining a space between each pair of cooling elements to introduce a flat piece, such that the cooling device is configured to simultaneously cool a plurality of flat pieces.

18. A method for cooling flat pieces, comprising:
a) providing a cooling device having:
a first cooling element having a first contact surface with a flat piece;
a second cooling element having a second contact surface with the flat piece;
wherein the first cooling element and second cooling element are located facing each other, defining a space between them to introduce the flat piece, and wherein the first cooling element comprises a cooling circuit distributed along the first contact surface with the flat piece and the second cooling element comprises a cooling circuit distributed along the second contact surface with the flat piece, both circuits being configured for the continuous flow of a coolant fluid;
b) circulating the coolant fluid through the cooling circuit of the first and second cooling element and through the cooling circuit of the second cooling element;
c) introducing a flat piece into the space defined between the first cooling element and second cooling element;
d) keeping the flat piece in contact with the first contact surface of the first cooling element and with the second contact surface of the second cooling element for a pre-established time; the pre-established time depending on an initial temperature and final temperature of the flat piece, and the temperature of the coolant fluid;
e) separating the first cooling element from the second cooling element by a movement system and removing the flat piece from the space defined between the first and second cooling element.

19. The method for cooling flat pieces of claim 18, wherein after introducing the flat piece into the space defined between the first cooling element and the second cooling element, a distance between the first and second cooling element is adjusted by the movement system of the first and second cooling elements so that the first contact surface and second contact surface come in contact with the flat piece.

20. The method for cooling flat pieces of claim 18, wherein the pre-established time during which the flat piece is kept in contact with the first and second contact surface of the first and second cooling element is at least one minute per millimeter of thickness of the flat pieces, when the coolant fluid is water at room temperature.
